(19) United States
(12) Patent Application Publication
(10) Pub. No.: US 2007/0052874 A1
(43) Pub. Date: Mar. 8, 2007

(54) Display apparatus including sensor in pixel

(75) Inventor: Takashi Nakamura, Saitama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/503,962

(22) Filed: Aug. 15, 2006

(30) Foreign Application Priority Data
Sep. 8, 2005 (JP) 2005-261253

(51) Int. Cl. H04N 5/70

(52) U.S. Cl. 348/801

(57) ABSTRACT

In order to shorten a horizontal period while allowing operations of pre-charging a sensor in a pixel and outputting a signal from the sensor, separately from a signal line, this display apparatus includes a supply line through which pre-charge voltage is supplied. In a period to write a video signal, a pre-charge circuit supplies the pre-charge voltage to a sensor through the supply line. Simultaneously, the detector detects a signal outputted from the sensor. In other words, the process of supply and detection are performed in parallel with the writing of the video signal.

### CROSS-REFERENCE TO RELATED APPLICATIONS

This application is based upon and claims the benefit of priority from Japanese Patent Application No. 2005-261253 filed on Sep. 8, 2005; the entire contents of which are incorporated herein by reference.

### BACKGROUND OF THE INVENTION

1. Field of the Invention

The present invention relates to a display apparatus having a function to read light that is incident from a screen by a sensor in a pixel.

2. Description of the Related Art

In recent years, display apparatuses like described in the Japanese Patent Laid-open publication 2004-318819 have been developed. Such a display apparatus includes pixels at individual intersections of scanning lines and signal lines, and it includes sensors in the individual pixels. The output of each sensor changes according to an amount of light received from a screen. The sensors are provided in order to sense that a human finger has approached to a touch panel for example.

In a display process, a period when a video signal is written in all the pixels corresponding to each scanning line is called a horizontal period. All the scanning lines are sequentially driven one by one, and the video signals are written in all scanning lines, thus one frame of an image is formed.

During one horizontal period, the following two processes are performed in addition to writing of the video signal: one is a process to pre-charge capacitors of the sensors up to a voltage; and the other one is a process to output, from another sensor, a signal indicating whether the voltage of each capacitor pre-charged in advance has changed with external light. For supplying pre-charge voltage to the sensors and outputting the signals from the sensors, heretofore, the signal lines have been used.

However, in the case that the number of pixels increases with an increase in resolution, it is necessary to shorten the horizontal period in order to display one frame of an image without increasing time required to form the image. Accordingly, there is a problem that the pre-charge and output processes are not adequately performed in this shorten horizontal period.

### SUMMAY OF THE INVENTION

An object of the present invention is to allow processes of pre-charging sensors and outputting signals from the sensors to be performed even when the horizontal period is shortened.

A first aspect of the present invention is that a display apparatus includes: a pixel placed at an intersection of a scanning line and a signal line; a sensor which is placed in the pixel and configured to change pre-charged voltage according to an amount of externally received light as an output signal; a supply line through which pre-charge voltage is supplied to the sensor; a pre-charge circuit configured to supply the pre-charge voltage to the supply line during a period when the scanning line and the signal line are driven to write a video signal in the pixel; and a detector configured to detect the signal outputted from the sensor during the period to write the video signal.

In the present invention, the supply line through which the pre-charge voltage is supplied is provided separately from the signal line. During the period to write the video signal, the pre-charge circuit supplies the pre-charge voltage through the supply line to the sensor, and the detector detects the output signal from the sensor. These processes of supply and detection are therefore not separately from but in parallel with the writing of the video signal, so that the horizontal period can be shortened.

The second aspect of the present invention is that the aforementioned display apparatus further includes an output line through which the signal from the sensor is outputted and that the detector detects the signal outputted through the output line.

In the present invention, the output line through which the signal from the sensor is outputted is provided separately from the signal line. During the period to write the video signal, the detector detects the signal outputted from the sensor through the output line. By using the output line in such a manner, the signal outputted from the sensor can be detected in a plenty of time.

A third aspect of the present invention is that in a period when the pre-charge voltage is being supplied to the sensor, the detector detects a signal outputted from another sensor.

In the present invention, the supply of the pre-charge voltage to the sensor and the detection of the signal outputted from the sensor are performed in parallel by the different sensors. Accordingly, the processes of supply and detection can be performed in a plenty of time.

A fourth aspect of the present invention is that the sensor includes: a source follower amplifier placed in an output section; and a photodiode and a capacitor which are connected in parallel between a gate and a source of the source follower amplifier and that the display apparatus further includes a circuit configured to supply constant voltage to a drain of the source follower amplifier.

In the present invention, the photodiode and capacitor are connected in parallel between the gate and source of the source follower amplifier. The drain of the source follower amplifier is supplied with constant voltage. When the photodiode causes the pre-charged voltage of the capacitor to be discharged because of an influence of external light, therefore, the drain voltage of the source follower amplifier varies. Accordingly, it is possible to obtain an output signal indicating a change according to an amount of external light.

A fifth aspect of the present invention is that the display apparatus further includes a switching element configured to switch electrical connection/disconnection between the supply line and an input section of the sensor and that the scanning line serves as a control line of the switching element.

In the present invention, the scanning line is configured to serve as the control line of the switching element provided in the input section of the sensor. Accordingly, the control line of the input section of the sensor does not need to be provided.

A sixth aspect of the present invention is that the display apparatus further includes a switching element configured to switch electrical connection/disconnection between the output line and an output section of the sensor and that the scanning line serves as a control line of the switching element.

In the present invention, the scanning line is configured to serve as the control line of the switching element provided in the output section of the sensor. Accordingly, the control line of the output section of the sensor does not need to be provided.

A seventh aspect of the present invention is that the display apparatus further includes: a pre-charge switching element configured to switch electrical connection/disconnection between the supply line and an input section of the sensor; and an output switching element configured to switch electrical connection/disconnection between the output line and an output section of the sensor. The scanning line serves as a control line of the pre-charge switching element, and the next scanning line serves as a control line of the output switching element. Moreover, the detector detects a signal outputted from the output switching element through the supply line.

In the present invention, the scanning line is configured to serve as the control lines of the pre-charge switching element and output switching element. Accordingly, the control lines do not need to be provided. Moreover, the supply line is configured to serve as the output line, and the output line does not need to be provided.

### BRIEF DESCRIPTION OF THE DRAWINGS

FIG. 1 shows a schematic circuit configuration of a display apparatus of the first embodiment.

FIG. 2 shows an equivalent circuit of a sensor-equipped pixel in FIG. 1.

FIG. 3 shows an internal circuit of the sensor in FIG. 2.

FIG. 4 is a timing chart showing an operation of the sensor-equipped pixel in FIG. 2.

FIG. 5 shows an equivalent circuit of the sensor-equipped pixel in a display apparatus of a comparative example.

FIG. 6 is a timing chart showing an operation of the sensor-equipped pixel in FIG. 5.

FIG. 7 shows an equivalent circuit of a sensor-equipped pixel in a display apparatus of the second embodiment.

FIG. 8 is a timing chart showing an operation of the sensor-equipped pixel in FIG. 7.

FIG. 9 shows an equivalent circuit of a sensor-equipped pixel in a display apparatus of the third embodiment.

### DESCRIPTION OF THE EMBODIMENTS

### First Embodiment

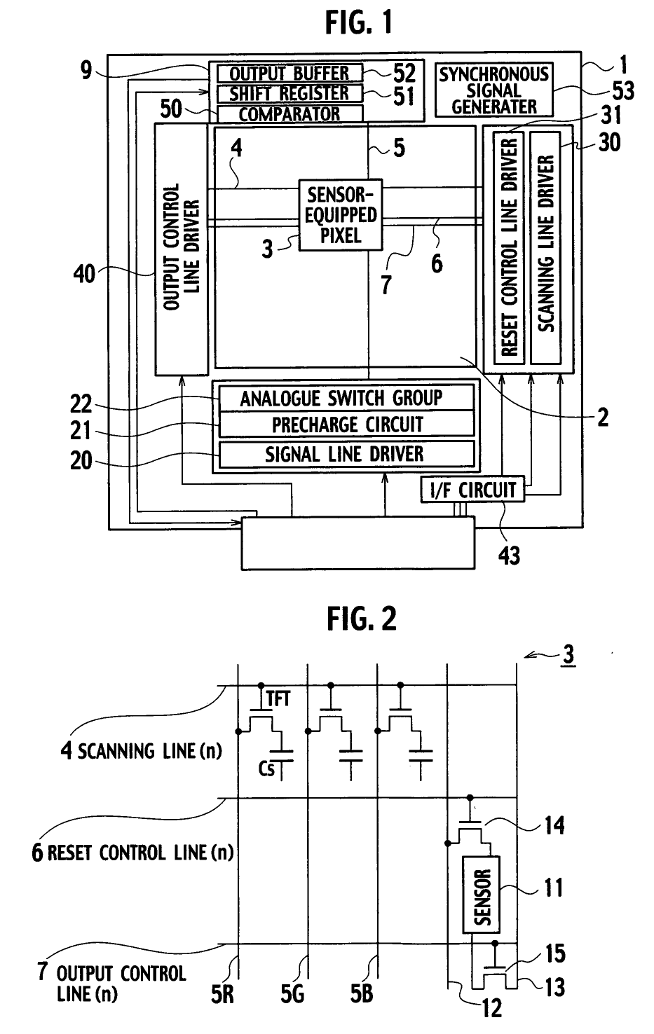

As shown in a block diagram of FIG. 1, the display apparatus of this embodiment includes a pixel area 2 and circuit areas to the right and left of and above and below the pixel area 2 on a glass substrate 1.

In the pixel area 2, scanning lines 4 and signal lines 5 are arranged so as to intersect each other. In the intersections thereof, pixels 3 each being equipped with a sensor are individually placed. An output signal of the sensor changes according to an amount of light externally received. Moreover, in the pixel area 2, reset control lines 6 and output control lines 7 are arranged in parallel to the scanning lines 4.

In the circuit area in bottom part, a signal line driver 20, a pre-charge circuit 21, and an analogue switch group 22 are placed. The signal line driver 20 supplies a video signal to the signal lines 5. The signal line driver 20 may be integrally formed on the glass substrate 1 by using a low-temperature poly-silicon technology, or a semiconductor chip on which the signal line driver 20 is formed may be mounted on the glass substrate 1. It is called COG (chip on glass) mounting.

The pre-charge circuit 21 supplies each line in the pixel area 2 with voltage from a power supply circuit based on control signals PRCR, PRCG, PRCB, PRCS1, and PRCS2 generated by a timing control unit.

The analogue switch group 22 is composed of a plurality of analogue switches which switch connection/disconnection between the signal lines 5 or other lines and the signal line driver 20 or pre-charge circuit 21.

In the circuit area of right part, a scanning line driver 30 and a reset control line driver 31 are placed. The scanning line driver 30 generates a control signal GATE to drive a thin-film transistor (TFT) of the pixel 3 and sequentially outputs it to the scanning lines 4. The reset control line driver 31 includes a shift register and a buffer circuit. This buffer circuit sequentially outputs a reset control signal CRT to the reset control lines 6 based on shift pulse propagating through the shift register.

In the circuit area of left part, an output control line driver 40 is placed. The output control line driver 40 includes a shift register and a buffer circuit. This buffer circuit sequentially outputs an output control signal OPT to the output control lines 7 based on shift pulses propagating through the shift register.

In the circuit area of top part, a detector 9 is placed. The detector 9 includes a comparator 50, a shift register 51, and an output buffer 52. The comparator 50 compares potentials of the signals outputted from the sensors with reference voltage and outputs results thereof. The results are stored in each stage of the shift register 51. The shift register 51 outputs data in synchronization with a control clock bit by bit. The output buffer 52 adjusts amplitude of an output signal of the shift register 51 so that the output signal matches an interface of an external IC or amplifies the same so that the output signal is appropriate for driving load up to the external IC. Moreover, in the top part, a synchronous signal generator 53 is placed.

Next, a configuration of each sensor-equipped pixel 3 is described. As shown in an equivalent circuit of FIG. 2, each pixel 3 is a combination of three dots of red (R), green (G), and blue (B). The pixel 3 includes three thin film transistors (TFTs), storage capacitors Cs, and pixel electrodes that are placed at respective intersections of each scanning line 4 and signal lines 5R, 5G, and 5B, and the pixel 3 further includes the sensor 11. Each TFT is a metal oxide semiconductor (MOS)-FET by way of example. Gates of the TFTs are connected to the scanning line 4; sources thereof are connected to the respective signal lines 5R, 5G, and 5B; and drains thereof are connected to the storage capacitors Cs and pixel electrodes in parallel. A suffix n in the drawing is a positive integer and indicates an order of the scanning line.

The sensor 11 is placed in an area defined by the reset control line 6, the output control line 7, a supply line 12, and an output line 13. The supply line 12 is one through which the pre-charge circuit 21 supplies the pre-charge voltage to the sensor 11. The output line 13 is one through which the signal from the sensor 11 is outputted to the detector 9. Between the supply line 12 and an input section of the sensor 11, a switching element 14 that switches connection/disconnection of them is connected. A control terminal of the switching element 14 is connected to the reset control line 6. Moreover, between the output line 13 and an output section of the sensor 11, a switching element 15 that switches connection/disconnection of them is connected. A control terminal of the switching element 15 is connected to the output control line 7. The switching elements 14 and 15 are thin-film transistors and are MOS-FETs by way of example.

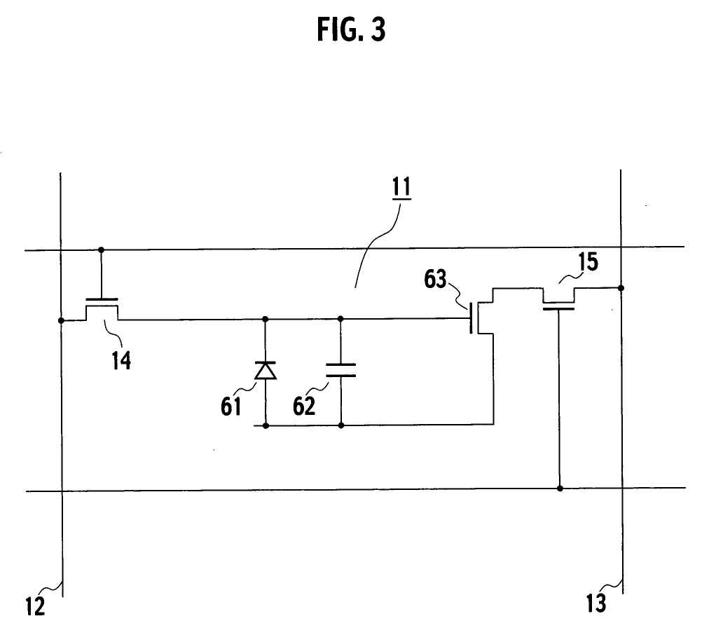

As shown in a circuit diagram of FIG. 3, the sensor 11 includes a source follower amplifier 63, a photodiode 61 and a capacitor 62. The source follower amplifier 63 is placed in the output section of the sensor 11. The photodiode 61 and the capacitor 62 are connected in parallel to each other between a gate and a source of the source follower amplifier 63.

While the switching elements 14 and 15 are on and off, respectively, the pre-charge circuit 21 supplies the pre-charge voltage to the capacitor 62 through the supply line 12 and switching element 14, and also outputs constant voltage to the output line 13. After the capacitor 62 is thus pre-charged and the switching element 14 is turned off, predetermined exposure time elapses. The potential of the capacitor 62 varies when leak current is generated in the photodiode 61 according to an amount of light incident from the outside of the screen. The potential of the capacitor 62 decreases as the leak current increases. When the capacitor 62 maintains the pre-charged potential, the source follower amplifier 63 is on. On the other hand, when the potential of the capacitor 62 is lowered, the source follower amplifier 63 turns off. When the switching element 15 is turned on after the exposure time has elapsed, the potential of the output line 13 is lowered in the case that the source follower amplifier 63 is on, and the potential of the output line 13 does not change in the case that the source follower amplifier 63 is off. The sensor 11 outputs the signal in such a manner. This outputted signal is transmitted to the detector 9 through the output line 13.

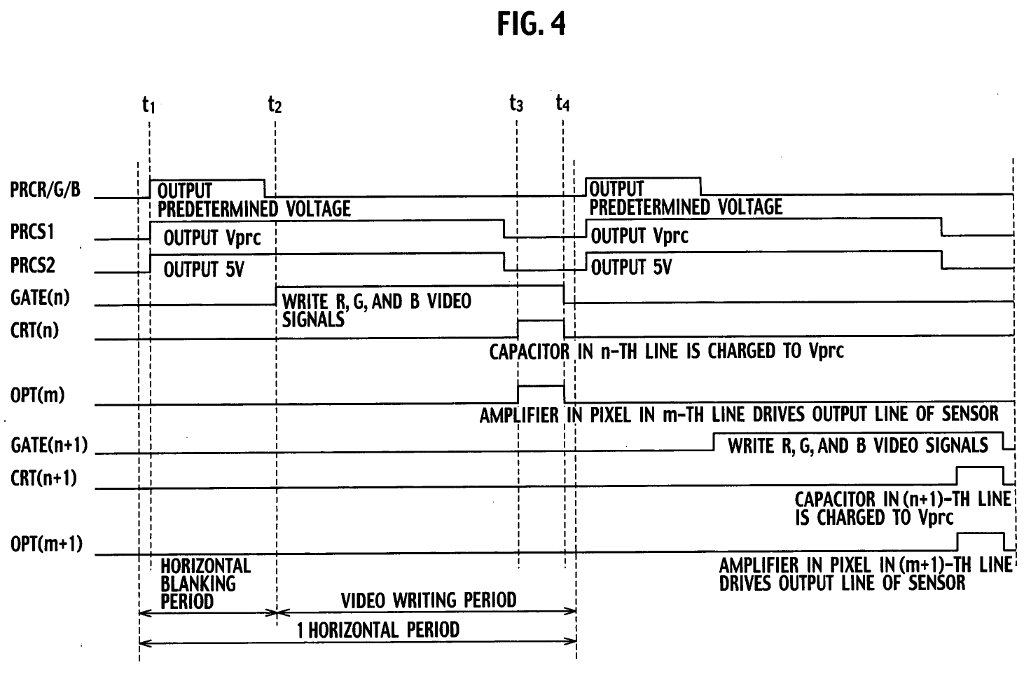

Next, an entire operation of the display apparatus is described by using a timing chart of FIG. 4. FIG. 4 shows a relationship among the control signals PRCR/PRCG/PRCB for the signal lines 5, the control signal PRCS1 for the supply lines 12, the control signal PRCS2 for the output lines 13, the control signal GATE(n) for the scanning line 4(n), the control signal CRT(n) for the reset control line 6(n), and the control signal OPT(m) for the output control line 7(m). Note that suffixes n and m are positive integers different from each other and indicate orders of the scanning lines. In the same drawing, processes from time t₁ to t₄ are completed within one horizontal period.

At time t1, when the control signal PRCS1 becomes high, the pre-charge circuit 21 outputs pre-charge voltage Vprc to the supply lines 12. When the control signal PRCS2 becomes high, the pre-charge circuit 21 outputs constant voltage to the output lines 13. This voltage is 5V by way of example. The pre-charge voltage Vprc is adjusted according to environments including external light and temperature. When the control signals PRCR/PRCG/PRCB become high, the pre-charge circuit 21 outputs predetermined voltage to the signal lines 5R, 5G, and 5B.

At the time t2, when the scanning line driver 30 turns the control signal GATE(n) to high, the TFTs of all the pixels 3 connected to the n-th scanning line are turned on. The R, G, and B video signals outputted from the signal line driver 20 to the respective signal lines 5R, 5G, and 5B are thus written in the corresponding pixel electrodes and complementary capacitors Cs.

At the time t3, when the reset control line driver 31 turns the control signal CRT(n) to high, the switching elements 14 for pre-charge turn on to electrically connect the supply lines 12 and the input sections of the sensors 11. The capacitors 62 of the sensors 11 are thus charged to the pre-charge voltage Vprc that is held in the supply lines 12.

Moreover, when the output control line driver 40 turns the control signal OPT(m) to high, the switching elements 15 for output turn on to electrically connect the output sections of the sensors 11 (the output terminals of the source follower amplifiers 63) which correspond to the m-th scanning line and the output lines 13 respectively. In the case that the capacitors 62 maintain the pre-charge voltage, the respective source follower amplifiers 63 are on, and the potentials of the respective output lines 13 are reduced much lower than 5 V since. On the other hand, in the case that the potentials of the capacitors 62 are low, the respective source follower amplifiers 63 are off, and the potentials of the respective output lines 13 change little from 5 V. The signals are outputted from the sensors 11 in such a manner.

Herein, for example, m is assumed to be n+1 on the premise that the signals outputted from the sensors 11 by the control signal OPT(m) are signals pre-charged in the capacitors 62 one frame before. In other words, in a period when the pre-charge circuit 21 pre-charges the capacitors 62 of the n-th line, the detector 9 detects signals one frame before which are outputted by the source follower amplifiers 63 of the m-th line. The pre-charge circuit 21 then pre-charges the capacitors 62 of the m-th line in the subsequent horizontal period. With such a configuration, a period to detect external light can be secured as the period of one frame after the sensors 11 in the same line are pre-charged. Accordingly, it is possible to effectively detect external light even in dark environments.

The processes of pre-charging the sensors 11 and outputting from the sensors 11 at the time t3 are performed in parallel with the process of writing the R, G, and B video signals to the respective signal lines 5R, 5G, and 5B. When the writing of the video signals is finished, the processes of pre-charging and outputting are finished, and one horizontal period is terminated. One horizontal period is, for example, 36 μs.

As described above, the processes of pre-charging the sensors 11 and outputting from the sensors 11 are performed in parallel with the writing of the video signals, which eliminates the need for these processes to be performed in a horizontal blanking period, when video signals are not written. Accordingly, the horizontal period can be shortened.

### COMPARATIVE EXAMPLE

Next, a display apparatus of a comparative example is described to clarify the effect of the display apparatus of this embodiment.

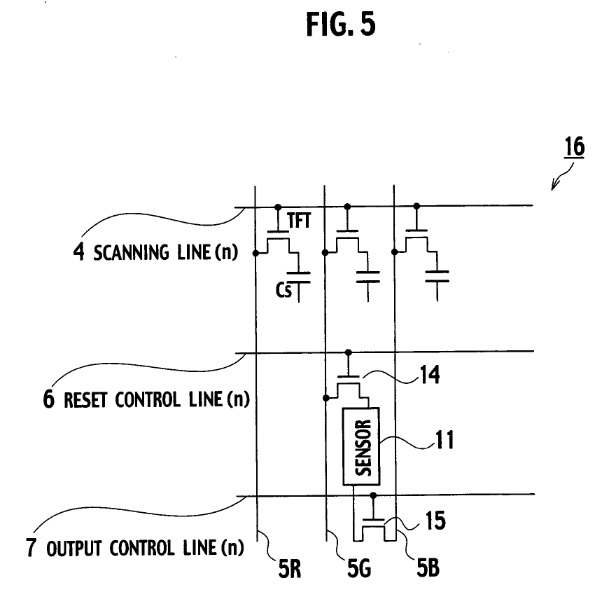

As shown in an equivalent circuit of FIG. 5, in each of sensor-equipped pixels 16 of comparative example, compared to the pixel 3 of FIG. 2, the signal line 5G is used as the supply line of the pre-charge voltage, and the signal line 5B is used as the output line of the signal from the sensor 11. In FIG. 5, the other same members as those of FIG. 2 are given the same reference numerals, and redundant descriptions thereof are omitted.

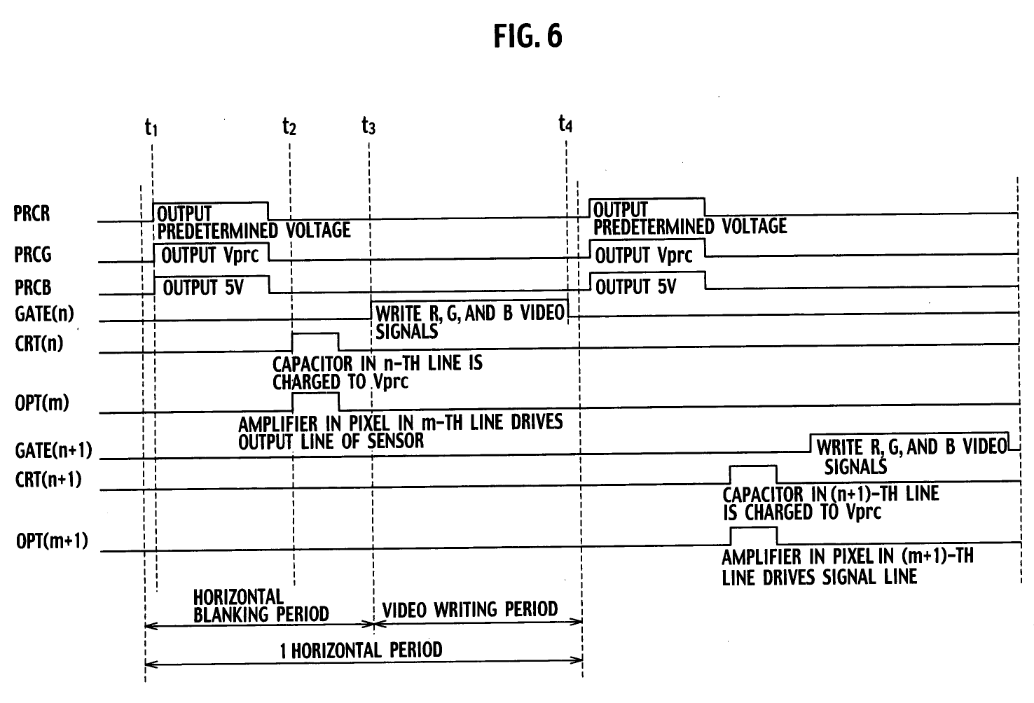

Next, an operation of the sensor-equipped pixels 16 is described by using a timing chart of FIG. 6. As shown in FIG. 6, the following processes from time t1 to t4 are performed within one horizontal period in the comparative example.

At the time t1, the control signals PRCR, PRCG, and PRCB individually become high. With the control signal PRCR, the pre-charge circuit outputs predetermined voltage to the signal line 5R. With the control signal PRCG, the pre-charge circuit outputs the pre-charge voltage Vprc to the signal line 5G. With the control signal PRCB, the pre-charge circuit outputs a voltage of 5V to the signal line 5B.

At the time t2, when the control signal CRT(n) becomes high, all the switching elements 14 connected to the reset control line 6(n) turn on, and the capacitors of the sensors 11 are charged to the pre-charge voltage Vprc held by the signal lines 5G. Moreover, when the control signal OPT(m) becomes high, all the switching elements 15 connected to the output control line 7(m) turn on to connect output terminals of the source follower amplifiers 63 of the sensors 11 to the signal lines 5B. In such a manner, signals indicating whether the respective potentials previously charged have varied are outputted.

At the time t3, when the control signal GATE(n) becomes high, all the TFTs of the pixels connected to the scanning line (n) turn on, and the R, G, and B video signals in the signal lines 5R, 5G, and 5B are written in the corresponding pixel electrodes. The writing of the video signals is then finished, and the horizontal period is finished. The one horizontal period is, for example, 50 μs. As described above, in the comparative example, the pre-charging the sensors 11 and outputting from the sensors 11 are performed in the horizontal blanking period, so that the horizontal period is longer than that of the aforementioned embodiment.

As described above, according to the first embodiment, the supply lines 12 through which pre-charge voltage is supplied are provided separately from the signal lines 5. During the period to write video signals, the pre-charge circuit 21 supplies the pre-charge voltage to the sensors 11 using the supply lines 12 while the detector 9 detects the output signals from the sensors 11. These processes of supply and detection are not performed separately from the writing of video signals but performed in parallel to the same. This eliminates the need for the supply and detection processes to be performed during the horizontal blanking period, thus the horizontal period can be shortened.

According to this embodiment, the output lines 13 through which the signals from the sensors 11 are outputted are provided separately from the signal lines 5. During the period to write video signals, the detector 9 detects the signals outputted from the sensors 11 using the output lines 13. By using the dedicated output lines 13 in such a manner, the output signals from the sensors 11 can be detected in a plenty of time.

According to this embodiment, in each sensor, the photodiode 61 and capacitor 62 are connected in parallel between the gate and source of the source follower amplifier 63. The pre-charge circuit 21 supplies constant voltage to the drain of the source follower amplifier 63 for pre-charge of the capacitor 62. When the photodiode 61 discharges the pre-charged voltage of the capacitor 62 because of the influence of external light, the drain voltage of the source follower amplifier 63 varies, thus it can be obtained an output signal which changes according to the amount of external light.

According to this embodiment, the supply of the pre-charge voltage to each sensor 11 and detection of the output signal from the sensor 11 are performed by different sensors in parallel, thus such supply and detection can be therefore performed in a plenty of time.

In this embodiment, both the supply lines 12 and output lines 13 of the sensors 11 are placed independently of the signal lines 5, but the placement thereof is not limited to this. For example, only the supply lines 12 may be placed independently of the signal lines 5. In this case, using devices that can perform the output operation at high speed as the source follower amplifiers 63 and outputting from the sensors 11 through the signal lines 5 can shorten the horizontal period.

### Second Embodiment

The basic configuration of a display apparatus of a second embodiment is similar to that of the display apparatus described in the first embodiment. The second embodiment is different from the first embodiment in that the scanning lines 4 serve as the reset control lines 6 to control the switching elements 14 for pre-charge.

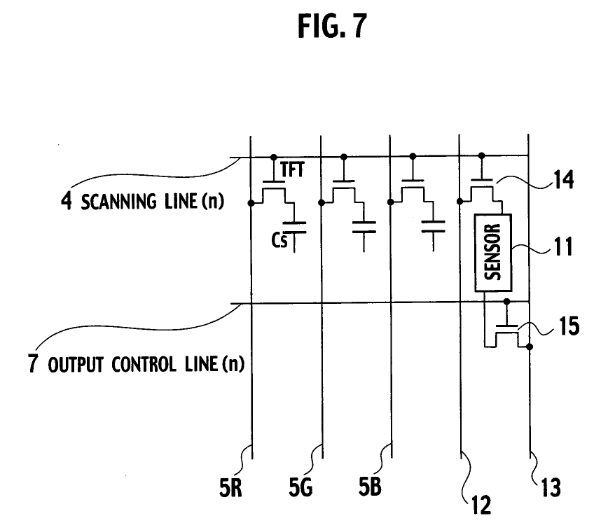

As shown in an equivalent circuit of FIG. 7, each of sensor-equipped pixels in the display apparatus of this embodiment does not include the reset control line 6 unlike FIG. 2, and the gate of the switching element 14 is connected to the scanning line 4. On the other hand, the gate of the switching element 15 for output is connected to the output control line 7 like FIG. 2. In FIG. 7, the other components same as those of FIG. 2 are given the same reference numerals, and redundant descriptions are omitted.

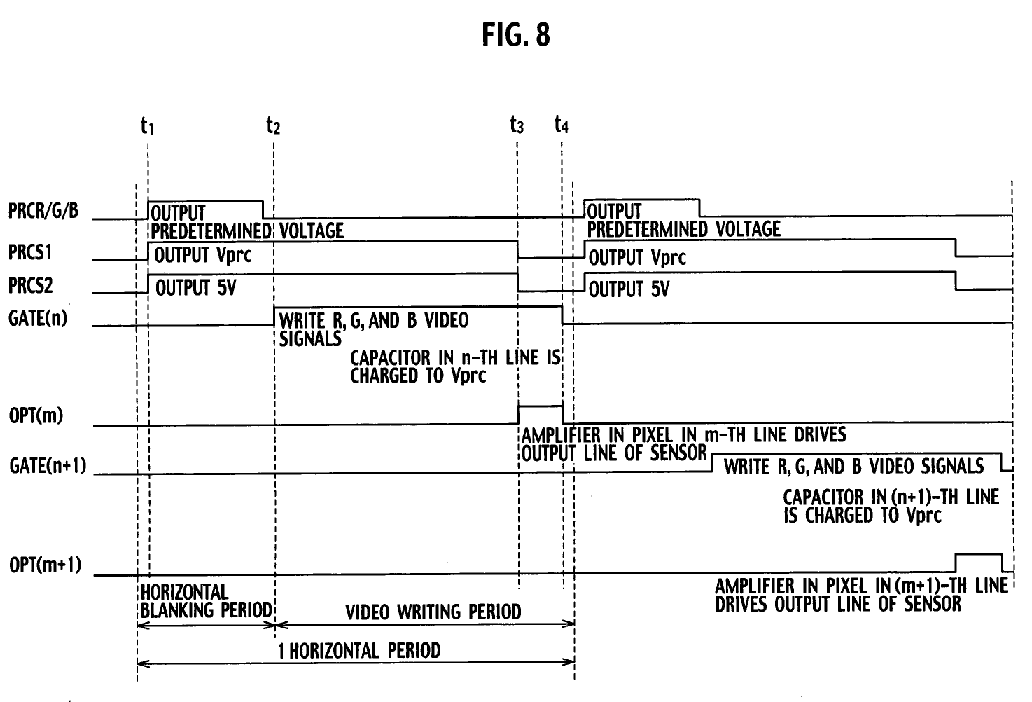

Next, an operation of the sensor-equipped pixels is described by using a timing chart of FIG. 8. FIG. 8 is basically the same as FIG. 4 but does not include the control signal CRT(n) for the reset control line 6(n).

At time t2, when the control signal GATE(n) becomes high, all the TFTs and switching elements 14 connected to the scanning line 4(n) turn on. The R, G, and B video signals held in the respective signal lines 5R, 5G, and 5B are written in the corresponding pixel electrodes through the TFTs. Simultaneously, the capacitors 62 of the sensors 11 are charged through the switching elements 14 to the voltage Vprc held in the supply line 12. The other part of the operation is the same as that of FIG. 4.

As described above, according to the second embodiment, the scanning lines 4 serve as the control lines of the switching elements 14 for pre-charge. This eliminates the need for the reset control lines 6 and accordingly increases a pixel aperture ratio in addition to the effect of the first embodiment. Furthermore, the reset control line driver 31 is unnecessary, thus the frame of the display apparatus can be miniaturized.

The scanning lines 4 are configured to serve as the control lines of the switching elements 14, but the configuration is not limited to this. For example, the scanning lines 4 may be configured to serve as the control lines of the switching elements 15 for output. In such a case, the output control lines 7 are unnecessary, and the pixel aperture ratio is increased in addition to the effect of the first embodiment. Furthermore, this eliminates the need for the output control line driver 40, so that the frame of the display apparatus can be reduced in size.

### Third Embodiment

The basic configuration of a display apparatus of a third embodiment is similar to that of the display apparatus described in the first embodiment. The third embodiment is different from the first embodiment in that the scanning lines 4 are configured to serve as the reset control lines 6 and output control lines 7 and that the supply lines 12 are configured to serve as the output lines 13.

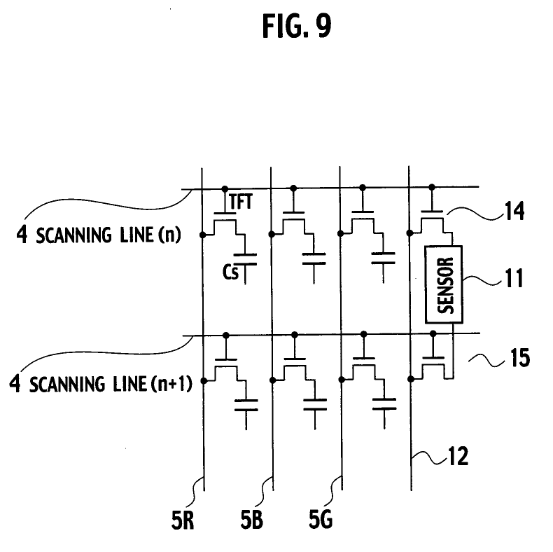

As shown in an equivalent circuit of FIG. 9, each of sensor-equipped pixels in the display apparatus of this embodiment does not include the reset control line 6, output control line 7, and output line 13 unlike FIG. 2. The gate of the switching element 14 is connected to the scanning line 4(n). The gate of the switching element 15 is connected to the scanning line 4(n+1), and the output terminal of the switching element 15 is connected to the supply line 12. The supply line 12 includes both functions to transmit to the sensor 11 pre-charge voltage supplied from the pre-charge circuit 21 and to transmit to the detector 9 the signal outputted from the sensor 11. In FIG. 9, the other members same as those in FIG. 2 are given the same reference numerals, and redundant descriptions thereof are omitted.

Next, an operation of the sensor-equipped pixels is described by using FIG. 8. However, in this embodiment, the output control signal OPT(m) for the output lines is not used as shown in the timing chart.

At the time t2, when the control signal GATE(n) of the n-th line becomes high, all the TFTs and switching elements 14 connected to the scanning line 4(n) turn on. The R, G, and B video signals held by the respective signal lines 5R, 5G, and 5B are written in the corresponding pixel electrodes through the TFTs. Simultaneously, the capacitors 62 of the sensors 11 are charged to the pre-charge voltage Vprc held by the supply lines 12 through the switching elements 14.

In the next horizontal period, when the control line signal GATE(n+1) of the (n+1)-th line becomes high, all the TFTs and switching elements 14 connected to the scanning line 4(n+1) turn on. The R, G, and B video signals held by the respective signal lines 5R, 5G, and 5B are written in the corresponding pixel electrodes of the (n+1)-th line through the TFTs. Simultaneously, the output terminals of the source follower amplifiers 63 of the pixels of the n-th line and the supply lines 12 are electrically connected through the switching elements 15, and the signals from the sensors 11 are outputted to the detector 9 through the supply lines 12. The other part of the operation is the same as that of FIG. 8.

As described above, according to the third embodiment, the scanning line 4(n) and the scanning line 4(n+1) serve as the control lines of the switching elements 14 for pre-charge and of the switching elements 15 for output. This eliminates the need for the reset control lines 6 and output control lines 7, thus achieving a pixel aperture ratio higher than that of the second embodiment.

According to this embodiment, the reset control line driver 31 and the output control line driver 40 are unnecessary, thus the frame of the display apparatus can be reduced in size.

According to this embodiment, the supply lines 12 serve as the output lines 13. This eliminates the need for the output lines 13 and further increases the pixel aperture ratio.

What is claimed is:

1. A display apparatus, comprising:
a pixel placed at an intersection of a scanning line and a signal line;
a sensor which is placed in the pixel and configured to change pre-charged voltage according to an amount of externally received light as an output signal;
a supply line through which the pre-charge voltage is supplied to the sensor;
a pre-charge circuit configured to supply the pre-charge voltage to the supply line during a period when the scanning line and the signal line are driven to write a video signal in the pixel; and
a detector configured to detect the signal outputted from the sensor during the period to write the video signal.

2. The display apparatus according to claim 1, further comprising:
an output line through which the signal from the sensor is outputted, wherein
the detector detects the signal outputted through the output line.

3. The display apparatus according to claim 1, wherein
in a period when the pre-charge voltage is being supplied to the sensor, the detector detects a signal outputted from another sensor.

4. The display apparatus according to claim 1, wherein
the sensor includes: a source follower amplifier placed in an output section; and a photodiode and a capacitor which are connected in parallel between a gate and a source of the source follower amplifier, and
the display apparatus further includes a circuit configured to supply constant voltage to a drain of the source follower amplifier.

5. The display apparatus according to claim 1, further comprising:
a switching element configured to switch electrical connection/disconnection between the supply line and an input section of the sensor, wherein
the scanning line serves as a control line of the switching element.

6. The display apparatus according to claim 2, further comprising:
a switching element configured to switch electrical connection/disconnection between the output line and an output section of the sensor, wherein
the scanning line serves as a control line of the switching element.

7. The display apparatus according to claim 1, further comprising:
a pre-charge switching element configured to switch electrical connection/disconnection between the supply line and an input section of the sensor; and
an output switching element configured to switch electrical connection/disconnection between the output line and an output section of the sensor, wherein
the scanning line serves as a control line of the pre-charge switching element, and the next scanning line serves as a control line of the output switching element, and
the detector detects a signal outputted from the output switching element through the supply line.
